(19) United States
(12) Patent Application Publication
(10) Pub. No.: US 2006/0061140 A1
(43) Pub. Date: Mar. 23, 2006

(54) Method for manufacturing a vehicle interior paneling part, and vehicle interior paneling part

(75) Inventors: Dominik Schuetz, Waldaschaff (DE); Manfred Heimberger, Waldaschaff (DE); Konrad Missbach, Aschaffenburg (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/232,264

(22) Filed: Sep. 21, 2005

(30) Foreign Application Priority Data
Sep. 21, 2004 (DE) 10 2004 045 757.3

(51) Int. Cl. B60J 7/00

(52) U.S. Cl. 296/201

(57) ABSTRACT

A method for manufacturing a vehicle interior paneling part, especially a gas bag cover, includes the positioning of a decorative part in one of an injection and foaming mold, the decorative part having a visible front part in the assembled state and an anchor part that extends therefrom on a rear side. A subsequent partial injection- or partial foam-molding around the decorative part takes place to generate a cover plate and to embed the anchor part at least partially in the cover plate. Thereby, a vehicle interior paneling part is produced.

### TECHNICAL FIELD

The present invention relates to a method for manufacturing a vehicle interior paneling part, as well as a vehicle interior paneling part.

### BACKGROUND OF THE INVENTION

U.S. Pat. No. 5,685,056 discloses a method, in which, in a first step, a large-surface cover plate of a gas bag cover made of plastic is injection molded. In a second step, an emblem is inserted into a hole in the cover plate. The emblem has an extension, which extends through the hole and protrudes from the opposite side of the cover plate. The protruding section is then crimped, as a result of which it is supported on the opposite side of the cover plate. Subsequently, the decorative part is securely attached to the cover plate.

The disadvantage of this method is that a plurality of method steps is necessary in order to attach a decorative part of this type to a cover plate. This in turn results in increased costs, which are to be avoided.

### BRIEF SUMMARY OF THE INVENTION

Therefore, according to the present invention, provision is made that the decorative part is already joined to the cover plate during the injection- or foam-molding process. In this context, provision is made that the decorative part has a front part that is visible in the assembled state and an anchor part that extends therefrom on a reverse side, the decorative part being positioned in one of an injection and foaming mold. Subsequently, one of an injection- and foam-molding process is carried out around the decorative part to generate the cover plate and to embed the anchor part at least partially in the cover plate. Therefore, the cover plate is joined to the decorative part as the cover plate is manufactured, which renders the method faster and cheaper.

In this context, the anchor part can be designed in different ways. For example, the anchor part can have an undercut, into which liquid plastic flows during the injection- or foam-molding process. As a result, the anchor part becomes altogether narrower, which also makes the decorative part lighter. In addition, a form-locking connection between the decorative part and the cover plate is assured, so that the decorative part cannot be pressed in when pressure is exerted on the decorative part from outside, for example by a vehicle occupant.

The decorative part can be positioned in the cover plate such that the anchor part does not protrude with respect to the cover plate, i.e., so that it is completely embedded in the cover plate.

In the method according to the present invention, it can be provided that the injection or foaming mold has a recess, which, when the decorative part is being positioned, accommodates the front part. After the injection- or foam-molding of the cover plate, the vehicle interior paneling part is therefore no longer flat due to the decorative part that now partially protrudes, which produces a high-quality overall impression. Therefore, a vehicle occupant can also feel the decorative part.

The vehicle interior paneling part according to the present invention is manufactured in the following manner. First, a decorative part having a visible front part in the assembled state and an anchor part that extends therefrom on a reverse side is positioned in one of an injection and foaming mold. Then one of partial injection- and partial foam-molding is carried out around said decorative part to generate a cover plate and to embed said anchor part at least partially in said cover plate.

According to the preferred embodiment, provision is made that the decorative part is embedded in the cover plate in a form-locking manner, the decorative part having portions extending transverse with respect to a visible surface of the cover plate and portions extending perpendicular thereto, the portions being embedded in the cover plate. This prevents the decorative part from shifting or detaching.

In the vehicle interior paneling part according to the present invention, the decorative part is attached to the cover plate without requiring a supplemental attachment means. As a result, a supplemental assembly step may be omitted, i.e., no additional screwing or riveting of the decorative part is necessary.

An especially high-quality impression is achieved when the decorative part is made of metal.

Specifically, because a decorative part that is made of metal, due to its weight, must be fixedly attached to the cover plate, the anchor part can have a section that immediately adjoins the front part, the section extending laterally outwards into the cover plate. Therefore, the decorative part is prevented from detaching in the direction of the vehicle interior. The section that adjoins the front part preferably extends obliquely outwards and towards a reverse side, so that a cross section is produced that extends conically outwards.

### BRIEF DESCRIPTION OF THE DRAWINGS

FIG. 1 depicts a front view of a vehicle interior paneling part according to the present invention that is manufactured using the method according to the present invention;

FIG. 2 depicts a mold for manufacturing the vehicle interior paneling part according to the present invention having mounted decorative parts;

FIG. 3 depicts a sectional view of the vehicle interior paneling along line III-III in FIG. 1;

FIG. 4 depicts a corresponding sectional view of a vehicle interior paneling according to a second embodiment; and

FIG. 5 depicts a corresponding sectional view of a vehicle interior paneling according to a third embodiment.

### DETAILED DESCRIPTION OF THE PREFERRED EMBODIMENTS

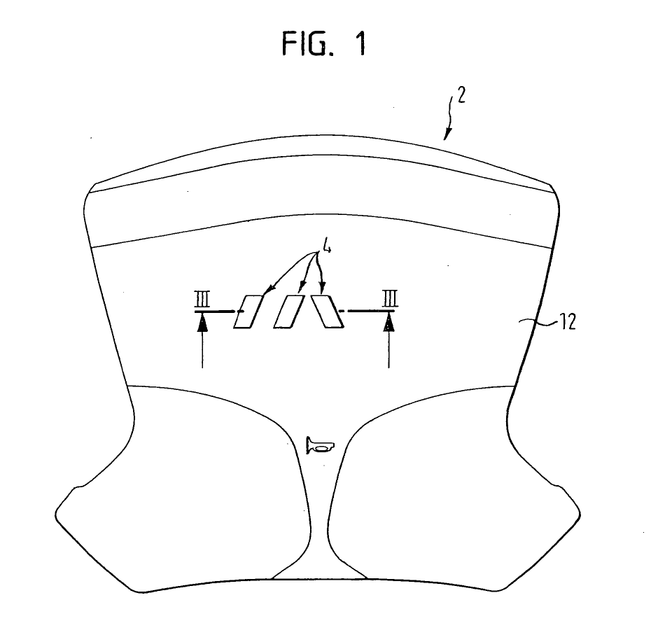

FIG. 1 depicts a vehicle interior paneling part in the form of a gas bag cover 2, made up of a cover plate 12 and decorative parts 4 that are visible on the front side.

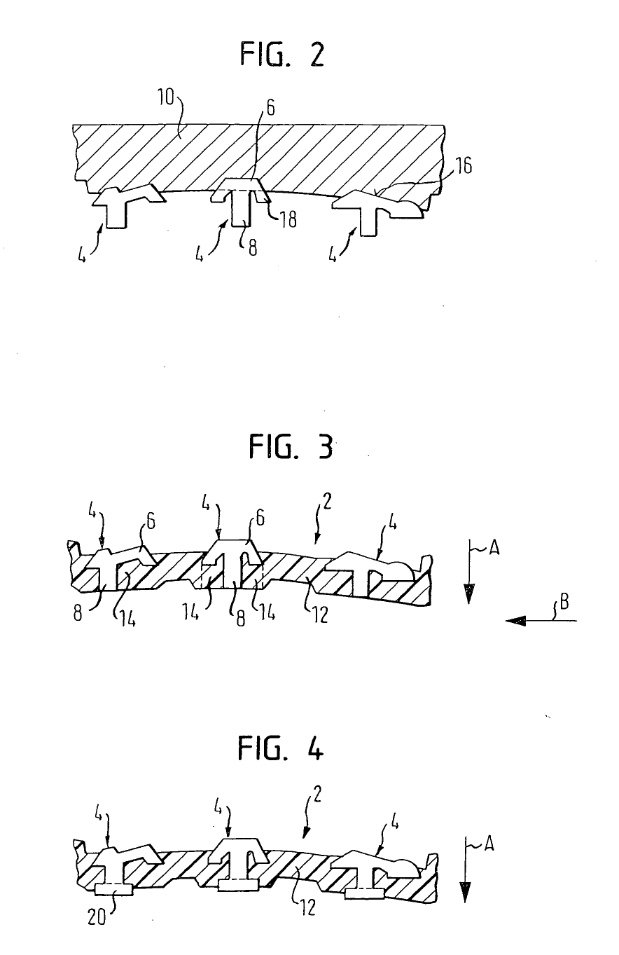

FIG. 2 depicts an upper part of an injection or foaming mold 10, for manufacturing the gas bag cover 2 shown in FIG. 1. Foaming mold 10 has recesses 16, into which, for positioning purposes, decorative parts 4 partially extend before the injection- or foam-molding process. In this context, each decorative part 4 can be subdivided into two imaginary sections, a front part 6 and an anchor part 8. Front part 6 is completely accommodated in recess 16 of foaming mold 10, the recess being complementary to the front side, and anchor part 8 is situated outside of recess 16. Anchor part 8 has a section 18 that immediately adjoins front part 6, section 18 extending preferably obliquely outwards and towards the reverse side of cover plate 12, i.e., the “head” of decorative part 4 obliquely converges in the direction of the front side.

In a following step, large-surface cover plate 12 is manufactured using an injection- or foam-molding process. During the injection- or foam-molding process, anchor part 8 of each decorative part 4 is surrounded by liquid plastic. During this, anchor part 8 of decorative part 4 is partially or completely embedded in the plastic that constitutes cover plate 12.

Finished gas bag cover 2, made up of cover plate 12 and decorative parts 4, is depicted in FIG. 3. Cover plate 12 has a dimension that is large in relation to decorative parts 4 (see also FIG. 1). Due to recess 16 in foaming mold 10, in the completed gas bag cover 2 decorative part 4 protrudes beyond cover plate 12 a certain amount in the direction of the front side. This amount corresponds to the height of recess 16. In the event that no recess 16 is provided in foaming mold 10, decorative part 4 lies flush with cover plate 12. This means that in the direction of sight B, there would be no visible difference in height between the surface of decorative part 4 and the surface of cover plate 12.

In FIG. 3, an undercut 14 of decorative parts 4 can be seen with respect to direction A, the undercut being completely filled with the plastic. FIG. 3 also shows that decorative parts 4 are embedded in cover plate 12 in a gapless manner.

Other materials besides metal are also conceivable for decorative part 4, e.g., plastic or wood. These materials may be painted or varnished as desired. If a decorative part 4 made of plastic is used, it can also be provided with a metallic surface.

FIG. 4 shows a second embodiment of gas bag cover 2, in which decorative parts 4 have a supplemental retaining element 20. A retaining element 20 of this type could be used when the most stable possible anchoring is desired for decorative part 4 in cover plate 12.

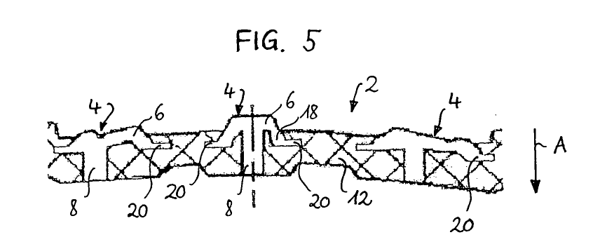

Alternatively or additionally, sections 18, which extend obliquely outwards, can be provided with retaining elements 20, these retaining elements extending preferably normal to a center line of the anchor parts (see FIG. 5).

Another possibility is to furnish decorative part 4 with barbs so that detaching decorative part 4 is made more difficult both in direction A and in the opposite direction. Of course, it is also conceivable to fasten decorative part 4 on cover plate 12 using a supplemental attachment device. In this context, a combination of a washer and a screw could be employed, the screw engaging on decorative part 4 and the washer preventing decorative part 4 from detaching.

Decorative parts 4, more precisely their anchor parts 8, can be joined to each other by a connecting member. As a result, decorative parts 4 can be positioned in the foaming mold more simply and more rapidly. In addition, the connecting member after the foaming process has a more powerful grip in cover plate 12.

Furthermore, the surface of anchor part 8 of decorative part 4 can be configured so that it has the greatest possible roughness. In conjunction with the surrounding plastic, this can make for an improved grip of decorative part 4 in cover plate 12.

1. A method for manufacturing a vehicle interior paneling part, especially a gas bag cover (2), comprising the following steps:
positioning of a decorative part (4) in one of an injection and foaming mold (10), said decorative part having a visible front part (6) in the assembled state and an anchor part (8) that extends therefrom on a reverse side,
one of partial injection- and partial foam-molding around said decorative part (4) to generate a cover plate (12) and to embed said anchor part (8) at least partially in said cover plate (12).

2. The method as recited in claim 1, wherein said anchor part (8) has an undercut (14), into which liquid plastic flows during one of said injection- and foam-molding process.

3. The method as recited in claim 1, wherein said anchor part (8) does not protrude with respect to said cover plate (12).

4. The method as recited in claim 1, wherein one of said injection and foaming mold (10) has a recess (16), which, when said decorative part (4) is being positioned, accommodates said front part (6), so that said front part (6) at least partially protrudes to an outside with respect to said cover plate (12).

5. A vehicle interior paneling part, manufactured by the following steps:
positioning of a decorative part (4) in one of an injection and foaming mold (10), said decorative part having a visible front part (6) in the assembled state and an anchor part (8) that extends therefrom on a reverse side,
one of partial injection- and partial foam-molding around said decorative part (4) to generate a cover plate (12) and to embed said anchor part (8) at least partially in said cover plate (12).

6. The vehicle interior paneling part as recited in claim 5, wherein said decorative part (4) is embedded in said cover plate (12) in a form-locking manner, said decorative part (4) having portions extending transverse with respect to a visible surface of said cover plate (12) and portions extending perpendicular thereto, said portions being embedded in said cover plate (12).

7. The vehicle interior paneling part as recited in claim 5, wherein said decorative part (4) is attached to said cover plate (12) without requiring a supplemental attachment means.

8. The vehicle interior paneling part as recited in claim 5, wherein said decorative part (4) is secured in said cover plate (12) in a gapless manner.

9. The vehicle interior paneling part as recited in claim 5, wherein said decorative part (4) is made of metal.

10. The vehicle interior paneling part as recited in claim 5, wherein said vehicle interior paneling part is a gas bag cover (2), and said cover plate (12) has a dimension that is large in relation to said decorative part (4).

11. The vehicle interior paneling part as recited in claim 5, wherein said anchor part (8) has a section (18) that immediately adjoins said front part (6), said section (18) extending laterally outwards into said cover plate (12).

12. The vehicle interior paneling part as recited in claim 11, wherein said section (18) that adjoins said front part (6) extends obliquely outwards and towards a reverse side of said cover plate (12).
